(19) United States
(12) Patent Application Publication
(10) Pub. No.: US 2005/0017111 A1
(43) Pub. Date: Jan. 27, 2005

(54) Tool for impinging material having a cast wear pad

(76) Inventor: Jeffrey T. Hickey, Bedford, PA (US)

Correspondence Address: Mr. Kevin P. Weldon;Patent Attorney, Kennametal Inc., P.O. Box 231, Latrobe, PA, 15650, US

(21) Appl. No.: 10/602,569

(22) Filed: Jun. 24, 2003

(51) Int. Cl. B02C 13/28

(52) U.S. Cl. 241/294

(57) ABSTRACT

A tool for impinging material wherein the tool is connected to a rotating drum. The tool comprises an elongate tool body that has opposite ends. The elongate tool body is connected at one end thereof to the rotating drum. The elongate tool body has a distal end opposite to the one end. The tool further has a wear pad that includes a central pad body that has an impingement face and an opposite attachment face. A pair flanges extend away from the attachment face. Each one of the flanges has an interior flange surface. The wear pad is attached to the elongate tool body at the distal end thereof. At least a portion of the flange interior surfaces and at least a portion of the attachment face is in close contact with the elongate tool body. The wear pad has a wear-resistant volume beginning near and extending inwardly from the impingement face thereof. The wear-resistant volume contains hard particles.

### BACKGROUND OF THE INVENTION

The invention relates to a tool for cutting or impinging material. In particular, the invention pertains to a tool for cutting or impinging material wherein the tool uses a cast wear pad that defines an impingement face that presents a cutting edge.

Heretofore, grinders (e.g., horizontal grinders and tub grinders) have been used to commutate or cut or grind or pulverize or disintegrate many types of materials. For example, grinders have been used to grind asphalt shingles for recycling along with asphalt hot mix for application to roadways. Grinders have also been used to grind mulch and other wood products.

Generally speaking, a grinder includes a hopper or the like that contains material to be ground by the grinder. The grinder further includes a powered (or driven) drum that includes a plurality of tools (e.g., a hammer bit) for impinging the material. These tools for impinging material have included a hard material that defines a cutting edge that impinges the material (e.g., asphalt shingles). Examples of these hard materials (or the parts that form these hard materials) have included a pre-formed tungsten carbide insert or a hardfacing material. While these types of hard materials have yielded acceptable performance, there have been some drawbacks with tools that use these hard materials.

The pre-formed tungsten carbide insert and the hardfacing have typically been applied only at (and sometimes in the vicinity of) the cutting edge.

These hard materials only have provided protection from wear due to the impingement at the specific areas where they were located on the tool. This means that the unprotected areas of the tool that experienced impingement-generated abrasion tended to wear away much quicker than the areas protected by the hard materials. The erosion of the unprotected portions of the tool decreased the integrity of the tool around the hard material thereby increasing the chance that the hard material became prematurely detached or dislodged from the tool. Obviously, this is an unsatisfactory situation.

The pre-formed tungsten carbide insert and the hardfacing that defined the cutting edge generally wore so as to cause the cutting edge to become blunt relatively early on in the grinding operation. Sometimes the cutting edges fractured during the grinding operation. When the cutting edges became blunt (or fractured), and hence, lost their integrity, the ability of the tool to cut (or impinge) effectively and aggressively diminished. This is an unsatisfactory situation.

It thus becomes apparent that it would be desirable to provide an improved tool for cutting or impinging material.

It is also desirable to provide an improved tool for cutting or impinging material that enhances the protection of the tool against early erosion that could compromise the integrity of the cutting ability of the tool.

It would also be desirable to provide an improved tool for cutting or impinging material that maintains the aggressive cutting ability of the tool through the lifetime of the tool.

It would also be desirable to provide an improved tool for cutting or impinging material that maintains the integrity of the cutting edge during the lifetime of the tool.

### SUMMARY OF THE INVENTION

In one form thereof, the invention is a tool for impinging material wherein the tool is connected to a rotating drum. The tool comprises an elongate tool body that has opposite ends. The elongate tool body is connected at one end thereof to the rotating drum. The elongate tool body has a distal end opposite to the one end. The tool further has a wear pad that includes a central pad body that has an impingement face and an opposite attachment face. A pair of flanges extend away from the attachment face. Each one of the flanges has an interior flange surface. The wear pad is attached to the elongate tool body at the distal end thereof. At least a portion of the flange interior surfaces and at least a portion of the attachment face are in close contact with the elongate tool body. The wear pad has a wear-resistant volume beginning near and extending inwardly from the impingement face thereof. The wear-resistant volume contains hard particles.

In yet another form thereof, the invention is a tool for impinging material wherein the tool is connected to a rotating drum. The tool comprises an elongate tool body that has opposite ends. The elongate tool body is connected at one end thereof to the rotating drum. The elongate tool body has a distal end opposite to the one end. A wear pad includes a central pad body that has an impingement face and an opposite attachment face. The central pad body further includes a pair of opposite side edges. Each one of integral flanges is contiguous with its corresponding one of the side edges. The integral flanges extend away from the attachment face. Each one of the integral flanges has an interior flange surface. The wear pad is attached to the elongate tool body at the distal end thereof. At least a portion of the flange interior surfaces and at least a portion of the attachment face are in close contact with the elongate tool body. The wear pad has a wear-resistant volume beginning near and extending inwardly from the impingement face thereof. The wear-resistant volume contains hard particles.

In still another form thereof, the invention is a tool for impinging material wherein the tool is connected to a rotating drum. The tool comprises an elongate tool body that has opposite ends. The elongate tool body is connected at one end thereof to the rotating drum. The elongate tool body has a distal end opposite to the one end. A wear pad includes a central pad body that has an impingement face and an opposite attachment face. A pair flanges extend away from the attachment face. Each one of the flanges has an interior flange surface. The wear pad is attached to the elongate tool body at the distal end thereof so that: at least a portion of the flange interior surfaces and at least a portion of the attachment face are in close contact with the elongate tool body; and a space defined between at least a portion of the flange interior surfaces and at least a portion of the attachment face is occupied by a portion of the elongate tool body at the distal end of the elongate tool body. The wear pad has a wear-resistant volume beginning near and extending inwardly from the impingement face thereof. The wear-resistant volume contains hard particles.

In another form thereof, the invention is a tool for impinging material for impacting material wherein the tool for impinging material is connected to a rotating drum. The tool for impinging material comprises an elongate tool body that has opposite ends. The elongate tool body is connected at one end thereof to the rotating drum. The elongate tool body has a distal end opposite to the one end. The elongate tool body has a head portion adjacent to the distal end thereof. A cast wear pad includes a central pad body that has an impingement face and an opposite attachment face. Integral flanges extend away from the attachment face. Each one of the flanges has an interior flange surface. The cast wear pad is welded to the elongate tool body at the distal end thereof. At least a portion of the flange interior surfaces and at least a portion of the attachment face are in close contact with the head portion of the elongate tool body. The cast wear pad has a wear-resistant volume beginning near and extending inwardly from the impingement face thereof. The wear-resistant volume contains hard particles cast therein wherein the wear-resistant volume extends to a selected depth in the cast wear pad from the impingement face.

### BRIEF DESCRIPTION OF THE DRAWINGS

The following is a brief description of the drawings that form a part of this patent application:

FIG. 1 is a schematic view of an arm connected to a brace (with a portion of the brace broken-away) wherein the brace is secured to a drum of a horizontal grinder wherein a tool for impinging (or cutting) material is attached to the arm at one end thereof;

FIG. 2 is a side view of one specific embodiment of a tool for impinging material wherein the tool comprises an elongate tool body attached to a cast wear pad;

FIG. 3 is a bottom view of the elongate tool body of the tool for impinging material shown in FIG. 2;

FIG. 4 is an isometric view of the cast wear pad used in conjunction with the tool for impinging material of FIG. 2;

FIG. 5 is a top view of the cast wear pad of FIG. 4;

FIG. 6 is a rear end view of the cast wear pad of FIG. 4;

FIG. 7 is a bottom view of the cast wear pad of FIG. 4 showing the impingement face of the cast wear pad;

FIG. 8 is a side view of the elongate tool body of the tool for impinging material of FIG. 2 with the cast wear pad removed and prior to a machining operation at the forward end of the tool body; and

FIG. 9 is a side view of the elongate tool body of the tool for impinging material shown in FIG. 2.

### DETAILED DESCRIPTION OF THE INVENTION

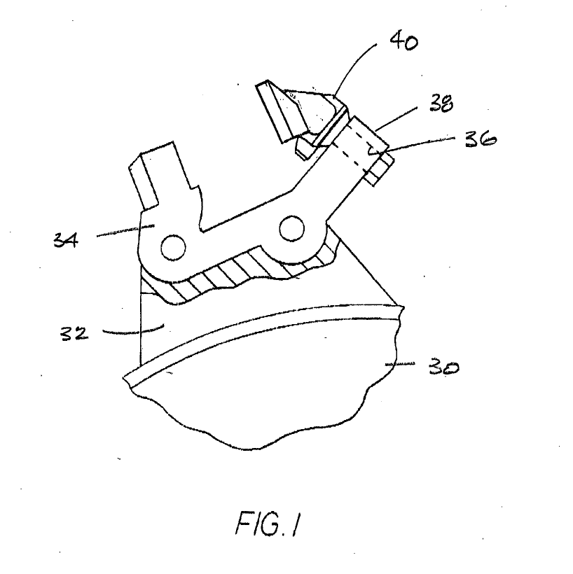

Referring to the drawings, FIG. 1 shows in mechanical schematic a drum 30 that is along the lines of a drum used in a horizontal grinder such as, for example, horizontal grinders such as the Bandit Models 2680, 3680 and 5680 made by Bandit Industries, Inc., 6750 Millbrook Dr., Remus, Mich. 49340 USA. A brace 32, which is shown broken away so as to expose the arm 34, is secured to the surface of the drum 30. The arm 34 is connected to the brace 32.

The arm 34 has a bore 36 at one end 38 thereof. A tool for impinging material (e.g., a hammer bit) 40 is connected to the arm 34 at a bore 36. The opposite end of the arm has another tool or bit connected thereto that presents a design different from that of the tool for impinging material 40. The tool for impinging material 40 has such an orientation relative to the material so that when the drum is driven, the tool for impinging material 40 will impinge upon (i.e., commutate or cut or grind or pulverize or disintegrate) the material. As can be appreciated, the tool for impinging material 40 is subjected to extreme forces in light of the fact that these grinders sometimes use 500 horsepower and greater engines to drive the drum. Applicant also contemplates that the tool for impinging material 40 may be used in applications other than grinding. These applications include shredding, mixing and pushing or forcing material through the machine.

The tool for impinging material 40 has an elongate tool body 44. Elongate tool body 44 has opposite ends that comprise one end 46 and an opposite distal end 48. Elongate tool body 44 further includes a generally cylindrical shank 50 beginning at and extending axial forward of the one end 46. Shank 50 contains a threaded portion 52 adjacent to the one end 46. The tool for impinging material 40 attaches to the drum via the treaded portion 52. As can be appreciated, the tool 40 is a non-rotatable tool in that the tool 40 does not rotate about its longitudinal axis during operation due to the threaded connection (either directly or indirectly through another structure) to the drum.

Elongate tool body 44 still further includes a head portion 56 beginning at and extending axial rearward of the distal end 48 of the elongate tool body 44. Head portion 56 presents a pair of side surfaces 58 and 59, an upper surface 60, and a lower surface 62. There is a generally frusto-conically shaped neck 64 generally mid-way along the length of the elongate tool body 44 wherein the neck 64 joins the shank 50 to the head portion 56.

The tool for impinging material 40 further contains a cast wear pad 70. Cast wear pad 70 has a central pad body 72 that in this specific embodiment has a generally rectangular shape. Central pad body 72 presents an impingement face 74 and an oppositely disposed attachment face 76. Central pad body 72 also has a pair of opposite side edges 78, 80, a forward edge 82, and a rear edge 84. A plurality of cutting edges 86 are defined at the intersections of the impingement face 74 and the opposite side edges 78 and 80, the forward edge 82 and the rear edge 84.

Cast wear pad 70 has a pair of integral upstanding flanges 90, 100 that project or extend away from the attachment face 76. Flange 90 is contiguous with the side edge 80.

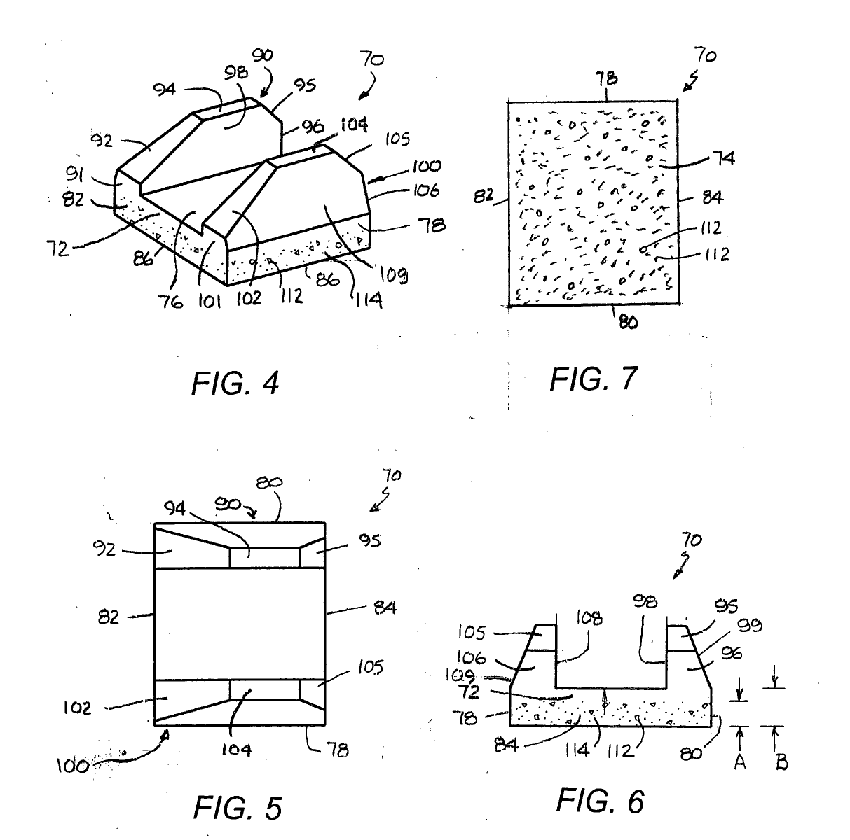

Referring to the structure of the flanges, one flange generally designated as 90 has a generally vertically disposed (as shown in FIG. 4) forward surface 91 that joins to an inclined forward surface 92. The transverse dimension of the inclined forward surface 92 decreases as the inclined forward surface 92 moves away from the forward edge 82 of the central pad body 72. The flange 90 further includes a top surface 94 that joins with the inclined forward surface 92. An inclined rear surface 95 joins with the top surface 94, and a generally vertically disposed (as shown in FIG. 4) a rear surface 96 joins with the inclined rear surface 95. The flange 90 also has an interior surface 98 and an exterior surface 99. The exterior surface 99 is angled inwardly as it moves away from the side edge 80.

Another flange generally designated as 100 has a generally vertically disposed (as shown in FIG. 4) forward surface 101 that joins to an inclined forward surface 102. The transverse dimension of the inclined forward surface 102 decreases as the inclined forward surface 102 moves away from the forward edge 82 of the central pad body 72. The flange 100 further includes a top surface 104 that joins with the inclined forward surface 102. An inclined rear surface 105 joins with the top surface 104, and a generally vertically disposed (as shown in FIG. 4) a rear surface 106 joins with the inclined rear surface 105. The flange 100 also has an interior surface 108 and an exterior surface 109. The exterior surface 109 is angled inwardly as it moves away from the side edge 78.

Cast wear pad 70 preferably is made through a casting process. One exemplary, and preferred, casting process is shown and described in U.S. Pat. No. 5,094,923 to Materkowski and U.S. Pat. No. 5,279,902 to Materkowski. These patents are hereby incorporated by reference herein. Generally speaking, in this process, hard particles can be selectively located and embedded into a cast steel matrix.

In this embodiment of the cast wear pad 70, a plurality of hard particles 112 are cast in the matrix of the cast wear pad 70 that is adjacent to the impingement face 74. The portion of this matrix that contains these hard particles 112 in concentration is called the wear-resistant volume 114. The typical material for the matrix is cast steel as disclosed in the Materkowski patents. Referring to FIG. 6, the wear-resistant volume 114 extends inwardly into the cast wear pad 70 a distance “A” from near (or at) the impingement face 74 wherein the central pad body 72 has a thickness “B”.

Although the values can vary depending upon the application, in a preferred embodiment the hard particles are tungsten carbide particles that have a size of -4+6 mesh. One alternative tungsten carbide particle size is −¼+4 mesh, and another tungsten carbide particle size is −12+18 mesh.

These tungsten carbide particles comprise about 90 weight percent of the portion of the cast wear pad 70 that comprises the wear-resistant volume 114. An alternative range for the tungsten carbide particle content of the wear-resistant volume is between about 75 weight percent and about 95 weight percent of the wear-resistant volume.

As shown in FIG. 7, the tungsten carbide particles 112 cover a portion of the surface area of impingement face 74. These tungsten carbide particles comprise about 80 percent of the surface area of the impingement face 74. An alternative range for the surface area of the impingement face 74 that comprises tungsten carbide particles is between about 65 percent and about 90 percent.

The wear-resistant volume 114 extends across the entire surface area of the impingement face 74. Because of this feature, the tool for impinging material 40 is not prone to the erosive wear of unprotected portions of the tool body wherein this erosive wear reduces or diminishes the structural integrity of the tool body or any hard material that forms the cutting edge.

The hard particles 112 in the cast wear pad 70 provide a self-sharpening feature. In this regard, the cast steel that surrounds the hard particles 112 wears away during use. This wear exposes the hard particles 112 so that the cast wear pad 70 maintains the ability to aggressively cut or impinge the material.

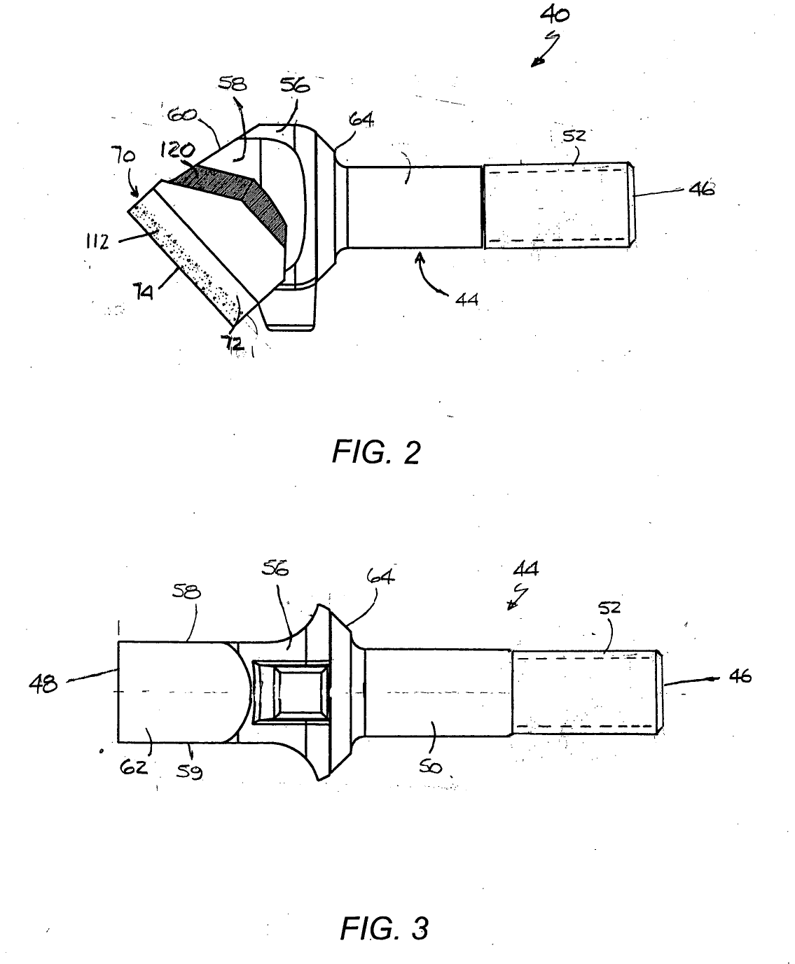

Cast wear pad 70 is attached to the elongate tool body 44 via welding. A weld bead 120 is shown in FIG. 2. However, it should be appreciated that the cast wear pad 70 and the elongate tool body 44 are also in close physical contact.

More specifically, at least a portion of the flange interior surfaces 98 and 108 and at least a portion of the attachment face 76 are in close contact with the head portion 56 of the elongate tool body 44. In this regard, the interior surface 98 of flange 90 is in close contact with the side surface 59 of the head portion 56, and the interior surface 108 of flange 100 is in close contact with the side surface 58 of the head portion 56. The attachment face 76 is in close contact with the lower surface 62 of the head portion 56.

As can be appreciated, the close physical contact between these corresponding surfaces helps stabilize the cast wear pad 70. Through the close physical contact between the cast wear pad 70 and the elongate tool body 44, as well as the presence of the flanges 90 and 100, the cast wear pad 70 is less prone to damage due to side loading thereon. The cast wear pad 70 is less prone to suffer corner or edge fracture during use due to the support and stabilization provided by the flanges 90 and 102, as well as by the close physical contact between the cast wear pad and the elongate tool body 44.

Applicant contemplates that the cast wear pad 70 may be secured to the elongate tool body 44 by means other than welding. For example, the cast wear pad may be brazed to the elongate tool body. As another example, the cast wear pad may be pinned or fastened with a fastener to the elongate tool body. As still another alternative, in light of the close fit between the head portion of the elongate tool body and the cast wear pad, there may be an interference fit between the cast wear pad and the elongate tool body.

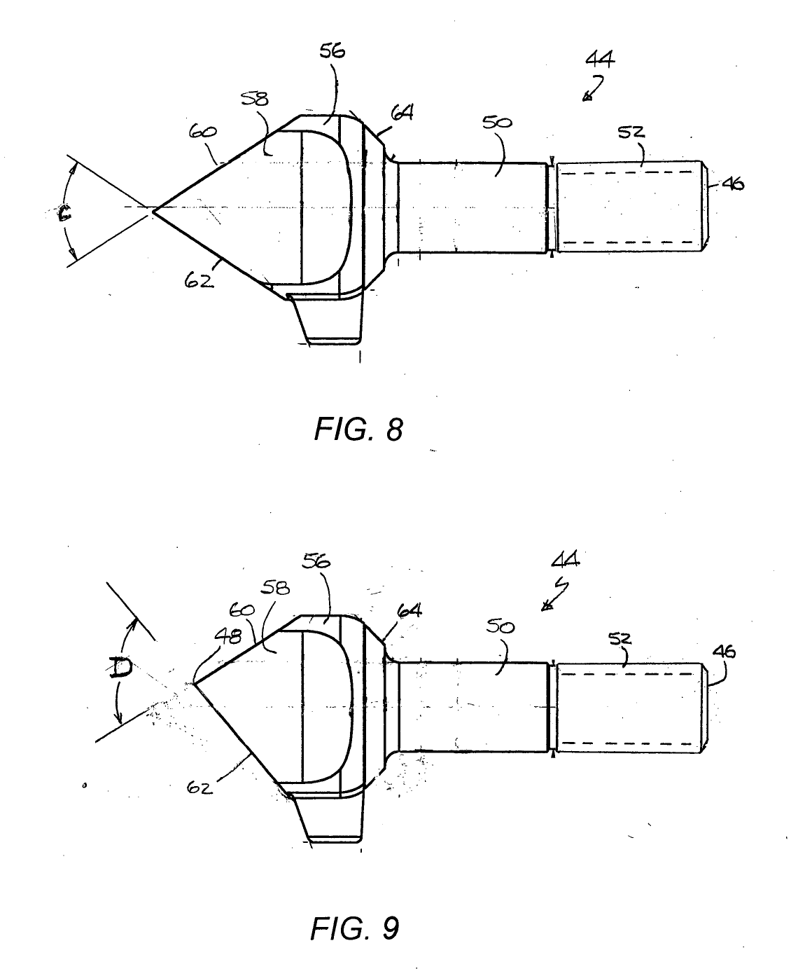

Referring to FIGS. 8 and 9, there is shown in FIG. 8 a side view of the elongate tool body without the cast wear pad and prior to a machining operation on the lower surface 62 of the head portion 56. The machining operation removes material from the lower surface 62 so as to increase the angle “C” between the upper surface 60 and the lower surface 62 of the head portion 56. The as-machined elongate tool body 44 is shown in FIG. 9.

As illustrated in FIG. 8, prior to the machining operation, the angle between the upper surface 60 and the lower surface 62 of the head portion 56 is angle “C”. As illustrated in FIG. 9, after the machining operation, the angle between the upper surface 60 and the lower surface 62 of the head portion 56 of the as-machined elongate tool body 44 is angle “D”. Angle “D” is greater than angle “C”. As a result of the machining operation, the length of the upper surface 60 is less than the length of the lower surface 62. The difference in these lengths of the upper surface 60 and the lower surface 62 helps establish the angle of attack for the tool for impinging material 40. One preferred magnitude for angle “C” is about 66 degrees. One preferred magnitude for angle “D” is about 80 degrees.

It can thus be seen that that the present invention provides an improved tool for cutting or impinging material. It is also apparent that the present invention provides an improved tool for cutting or impinging material that enhances the protection of the tool against early erosion that could compromise the integrity of the cutting ability of the tool. The present invention also provides an improved tool for cutting or impinging material that maintains the aggressive cutting ability of the tool through the lifetime of the tool. The present invention further provides an improved tool for cutting or impinging material that maintains the integrity of the cutting edge during the lifetime of the tool.

All patents, patent applications, articles and other documents identified herein are hereby incorporated by reference herein. Other embodiments of the invention may be apparent to those skilled in the art from a consideration of the specification or the practice of the invention disclosed herein. It is intended that the specification and any examples set forth herein be considered as illustrative only, with the true spirit and scope of the invention being indicated by the following claims.

1. A tool for impinging material wherein the tool is connected to a rotating drum, the tool comprising:
an elongate tool body having opposite ends, the elongate tool body being connected at one end thereof to the rotating drum, and the elongate tool body having a distal end opposite to the one end;
a wear pad including a central pad body having an impingement face and an opposite attachment face, at least a pair of flanges extending away from the attachment face, and each one of the flanges having an interior flange surface;
the wear pad being attached to the elongate tool body at the distal end thereof;
at least a portion of the flange interior surfaces and at least a portion of the attachment face being in close contact with the elongate tool body; and
the wear pad having a wear-resistant volume beginning near and extending inwardly from the impingement face thereof, and the wear-resistant volume containing hard particles.

2. The tool for impinging material of claim 1 wherein the impingement face includes a plurality of the hard particles.

3. The tool for impinging material of claim 2 wherein the impingement face having between about 65 percent and about 90 percent of the surface area thereof covered with the hard particles.

4. The tool for impinging material of claim 2 wherein the impingement face having at least about 80 percent of the surface area thereof covered with the hard particles.

5. The tool for impinging material of claim 1 wherein the wear-resistant volume containing between about 75 weight percent and about 95 weight percent hard particles.

6. The tool for impinging material of claim 1 wherein the central pad body further including at least a pair of opposite side edges, and each one of the integral flanges being contiguous with its corresponding one of the side edges.

7. The tool of impinging material of claim 6 wherein the elongate tool body having a head portion, and the head portion having opposite side surfaces and a lower surface.

8. The tool for impinging material of claim 7 wherein the flange interior surface of one of the flanges being in close contact with one of the side surfaces of the head portion, the flange interior surface of the other of the flanges being in close contact with other of the side surfaces of the head portion, and the attachment face of the wear pad being in other opposite close contact with the lower surface of the head portion.

9. The tool for impinging material of claim 6 wherein each one of the side edges and the impingement face intersect to form cutting edges.

10. The tool for impinging material of claim 1 wherein the wear pad being attached to the elongate tool body by welding.

11. A tool for impinging material wherein the tool is connected to a rotating drum, the tool comprising:
an elongate tool body having opposite ends, the elongate tool body being connected at one end thereof to the rotating drum, and the elongate tool body having a distal end opposite to the one end;
a wear pad including a central pad body, the central pad body having an impingement face and an opposite attachment face, the central pad body further including a pair of opposite side edges, at least a pair of integral flanges, each one of the integral flanges being contiguous with its corresponding one of the side edges, and the integral flanges extending away from the attachment face, and each one of the integral flanges having an interior flange surface;
the wear pad being attached to the elongate tool body at the distal end thereof;
at least a portion of the flange interior surfaces and at least a portion of the attachment face surface being in close contact with the elongate tool body; and
the wear pad having a wear-resistant volume beginning near and extending inwardly from the impingement face thereof, and the wear-resistant volume containing hard particles.

12. The tool of impinging material of claim 11 wherein the elongate tool body having a head portion, and the head portion having opposite side surfaces and a lower surface.

13. The tool for impinging material of claim 12 wherein the flange interior surface of one of the flanges being in close contact with one of the side surfaces of the head portion, the flange interior surface of the other of the flanges being in close contact with the other opposite side surface of the head portion, and the attachment face of the wear pad being in a close contact with the lower surface of the head portion.

14. The tool for impinging material of claim 11 wherein each one of the side edges and the impingement face intersect to form cutting edges.

15. A tool for impacting material wherein the tool is connected to a rotating drum, the tool comprising:
an elongate tool body having opposite ends, the elongate tool body being connected at one end thereof to the rotating drum, and the elongate tool body having a distal end opposite to the one end;
a wear pad including a central pad body having an impingement face and an opposite attachment face, at least a pair of flanges extending away from the attachment face, and each one of the flanges having an interior flange surface;
the wear pad being attached to the elongate tool body at the distal end thereof so that:
at least a portion of two of the flange interior surfaces and at least a portion of the attachment face being in close contact with the elongate tool body; and
a space defined between at least a portion of the flange interior surfaces and at least a portion of the attachment face being occupied by a portion of the elongate tool body at the distal end of the elongate tool body;
the wear pad having a wear-resistant volume beginning near and extending inwardly from the impingement face thereof, and the wear-resistant volume containing hard particles.

16. The tool of impinging material of claim 15 wherein the elongate tool body having a head portion, and the head portion having opposite side surfaces and a lower surface.

17. The tool for impinging material of claim 16 wherein the flange interior surface of one of the flanges being in close contact with one of the side surfaces of the head portion, the flange interior surface of other of the flanges being in close contact with the other opposite side surface of the head portion, and the attachment face of the wear pad being in close contact with the lower surface of the head portion.

18. The tool for impinging material of claim 15 wherein each one of the side edges and the impingement face intersect to form cutting edges.

19. The tool for impinging material of claim 15 wherein the impingement face includes a plurality of the hard particles.

20. A tool for impinging material wherein the tool for impinging material is connected to a rotating drum, the tool for impinging material comprising:
an elongate tool body having opposite ends, the elongate tool body being connected at one end thereof to the rotating drum, and the elongate tool body having a distal end opposite to the one end, and the elongate tool body having a head portion adjacent to the distal end thereof;
a cast wear pad including a central pad body having an impingement face and an opposite attachment face, at least a pair of integral flanges extending away from the attachment face, and each one of the flanges having an interior flange surface;
the cast wear pad being welded to the elongate tool body at the distal end thereof;
at least a portion of two of the flange interior surfaces and at least a portion of the attachment face being in close contact with the head portion of the elongate tool body; and
the cast wear pad having a wear-resistant volume beginning near and extending inwardly from the impingement face thereof, and the wear-resistant volume containing hard particles cast therein wherein the wear-resistant volume extends to a selected depth in the cast wear pad from the impingement face.
